(19) United States
(12) Patent Application Publication
(10) Pub. No.: US 2007/0183772 A1
(43) Pub. Date: Aug. 9, 2007

(54) Heat pumped surveillance camera housing and method of manufacturing the same

(75) Inventors: Cyrus Baldwin, San Diego, CA (US); Zachary Saielli, La Jolla, CA (US); Mark Creighton, Escondido, CA (US)

Correspondence Address: STETINA BRUNDA GARRED & BRUCKER, 75 ENTERPRISE, SUITE 250, ALISO VIEJO, CA, 92656, US

(73) Assignee: Dotworkz Systems, Inc.

(21) Appl. No.: 11/784,061

(22) Filed: Apr. 5, 2007

Related U.S. Application Data
(63) Continuation of application No. 10/976,373, filed on Oct. 29, 2004, now abandoned.
(60) Provisional application No. 60/516,339, filed on Oct. 31, 2003.

(51) Int. Cl. G03B 17/00

(52) U.S. Cl. 396/439

(57) ABSTRACT

An electronic device housing which may be cooled via a heat pump (e.g., heat exchange unit or thermo electric cooling mechanism) is provided. The housing may have a heat pump aperture sized and configured to receive the heat pump. The heat pump may comprise an internal heat sink positioned inside the housing and an external heat sink positioned exterior to the housing. A peltier module may be interposed between the internal and external heat sinks to transfer heat absorbed by the internal heat sink from the housing inside to the external heat sink. The external heat sink subsequently transfers the heat to the environment. Such heat transfer between the internal and external heat sinks may be further facilitated via an internal fan and external fan which are positioned adjacent to the internal and external heat sinks, respectively.

### CROSS-REFERENCE TO RELATED APPLICATIONS

This application claims the benefit of U.S. Provisional Application No. 60/516,339 filed Oct. 31, 2003, the substance of which is incorporated herein by reference.

### STATEMENT RE: FEDERALLY SPONSORED RESEARCH/DEVELOPMENT

Not Applicable

### BACKGROUND OF THE INVENTION

The present invention relates generally to a housing for a surveillance camera and more particularly to an actively cooled housing for operation in environments having extreme temperatures.

Video surveillance cameras have many applications. Depending on the type of application, a video surveillance camera may be mounted in a transparent dome housing, either from a ceiling in an indoor area, or attached to some other structure where the surveillance area is outdoors. Dome structures are used so that a camera can articulate within the dome to provide viewing over a wide area. It is preferable to have the dome completely encapsulate the camera to avoid dust and other debris from entering the dome and obscuring the camera's view. Because of the complete enclosure, the camera and housing may face problems associated with ambient temperature both inside and outside the dome, particularly where a surveillance camera is placed outdoors in harsh weather conditions.

Because of the dome's translucent nature, it can absorb sunlight and heat and create a “green house” effect and trap unwanted heat which may have a deleterious effect upon operation of the internal camera operation. In particularly harsh environments, the heat inside the dome may exceed the operating temperature of the camera or its associated servo-mechanisms which articulate the camera within the dome.

Accordingly, there is a need in the art to provide a camera device housing dome which is operable to lower the internal temperature to ensure effective operation of the surveillance camera.

### BRIEF SUMMARY OF THE INVENTION

In accordance with the present invention, an electronic device housing is provided. The electronic device housing may be modified or fabricated with a heat pump aperture to fit a heat pump. More particularly, the housing may further include an upper enclosure and a lower enclosure wherein the heat pump aperture may be formed in the upper enclosure. Moreover, a heat pump may be provided which may fit within the heat pump aperture to pump heat from inside to outside the housing to provide a housing inner temperature that is lower than the electronic device's operating temperature.

The heat pump may comprise a plurality of components, namely, an internal fan, internal heat sink, peltier module, more generally, heat exchange unit and thermo-electric cooling mechanism, external heat sink, external fan and a thermostat. The internal fan and internal heat sink may be positioned inside of the housing, whereas the external heat sink and the external fan may be positioned, at least in part, external to the housing. The peltier module may be interposed between the internal and external heat sinks so as to draw heat absorbed by the internal heat sink and transfer such drawn heat to the external heat sink to expel the transferred heat to the environment. The internal heat sink may have an internal fan adjacent thereto so as to circulate air within the housing such that the inside temperature of the housing is uniform and to draw air through heat fins of the internal heat sink. An external fan may be positioned adjacent to the external heat sink to circulate air away from its heat fins to thereby transfer heat to the environment. The external fan and the peltier module may be selectively activated or turned on/off based on a measured temperature within the housing monitored via a thermostat. The thermostat may be set to a predetermined temperature at an operating temperature of the electronic device or below the operating temperature of the electronic device. As the housing inside temperature rises to approach the operating temperature of the electronic device, the thermostat may activate the peltier module and the external fan once the measured temperature inside the housing is equal to or greater than the predetermined temperature. Conversely, as the housing inside temperature drops, the peltier module and the external fan may be turned off (i.e., deactivated) once the measured inside housing temperature is equal to or less than the predetermined temperature. The predetermined temperature being equal to or less than the operating temperature.

### BRIEF DESCRIPTION OF THE DRAWINGS

Features of the present invention will become more apparent upon reference to the drawings wherein:

FIG. 1 is a side cross sectional view of a surveillance camera housing with a heat pump attached thereto to pump heat within the housing to the environment (i.e., outside the housing);

FIG. 2 is a perspective view of an upper enclosure of the housing and heat pump;

FIG. 3 is an exploded view of the upper enclosure and the heat pump; and

FIG. 4 is a schematic diagram of the heat pump of FIG. 1.

### DETAILED DESCRIPTION OF THE INVENTION

The detailed description as set forth below in connection with the appended drawings is intended as a description of the embodiments of the present invention, and does not represent the only embodiment of the present invention. It is understood that various modifications to the invention may be comprised by different embodiments and are also encompassed within the spirit and scope of the present invention.

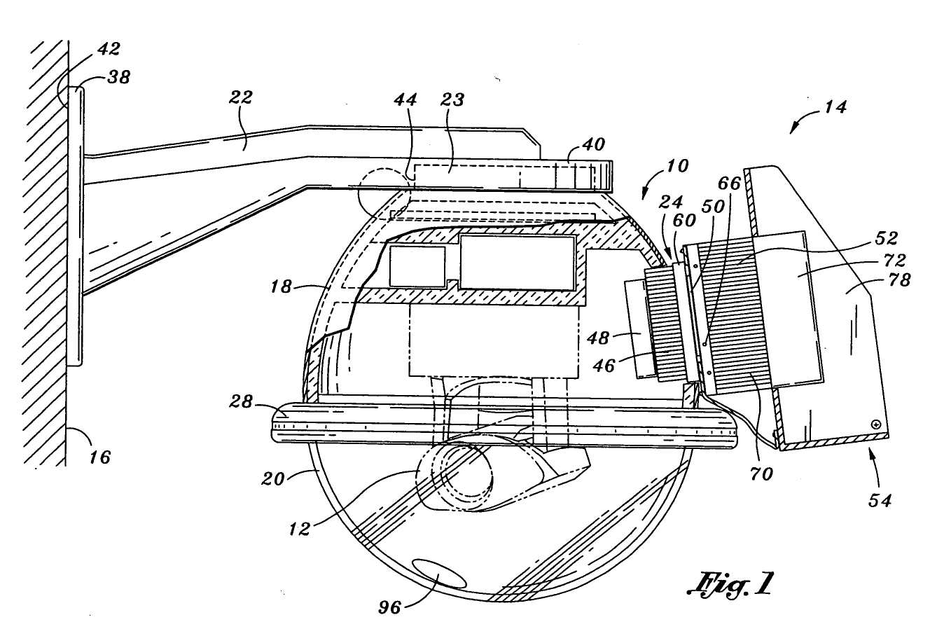

FIG. 1 illustrates a cross sectional view of a housing 10 containing a camera 12 and a heat pump 14, all of which are attached to a wall 16. In this regard, it is also contemplated within the scope of the present invention that the housing 10 of the present invention may contain any type of electronic equipment or object.

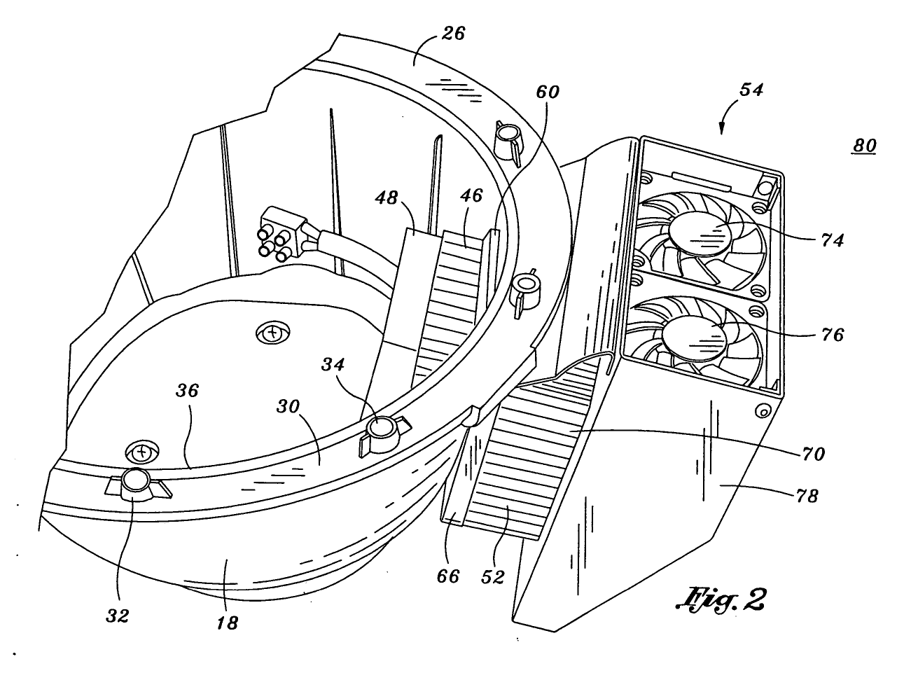

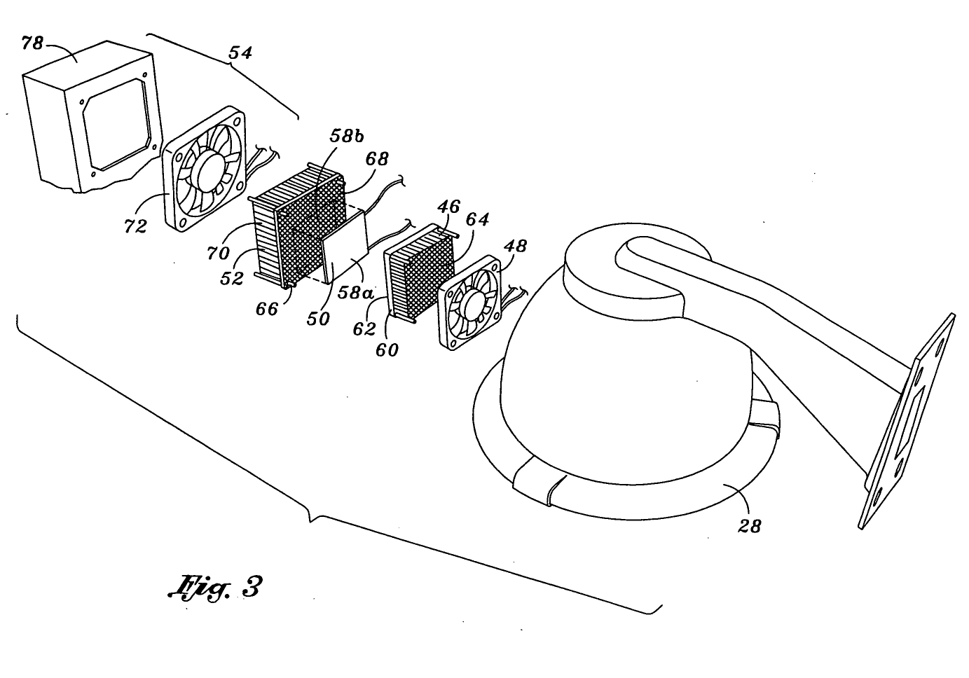

FIG. 1 further illustrates the housing 10 which may comprise an upper enclosure 18, lower enclosure 20, heat pump 14 and mounting bracket 22. The upper enclosure 18 may have a spherical configuration. Further, the upper enclosure may define a cylindrical top portion 23 (see FIG. 1) or a flat top surface (not shown) so as to provide an attachment point for the mounting brackets 22 to be discussed further below. The upper enclosure 18 may further define a heat pump aperture 24 (see FIG. 1) which may be sized and configured to receive the heat pump 14 to be discussed further below. The upper enclosure 18 may further define a periphery 26 (see FIG. 2) about a lower portion of the upper enclosure 18. The upper enclosure 18 may further define a shroud 28 (see FIGS. 1 and 3) about the periphery 26 which may be effective in preventing rain water from entering the housing 10. The shroud may define a lower surface 30 which may have posts 32 formed thereon. These posts 32 may further have an aperture 34 which may be internally threaded for the purposes of attaching the upper enclosure 18 to the lower enclosure 20. The upper enclosure 18 may further have attached to the periphery 26 an o-ring 36 or other type of sealant to form a seal between the upper and lower enclosures 18, 20.

The lower enclosure 20 may also define a periphery which is sized and configured to mate with the upper enclosure periphery 26. The lower enclosure periphery at an upper portion may define a lip which may engage the lower surface 30 of the upper enclosure shroud 28. The lip may have formed thereon a mating surface which engages the upper enclosure posts 32. The mating surface may also have an aperture therethrough so as to allow a screw or attachment mechanism to proceed through the aperture and internally thread onto the internal threads of the post 32. The lower enclosure 20 may also have a spherical configuration. In FIG. 1, the lower enclosure 20 has a semi spherical configuration. The lower enclosure 20 may be fabricated from a transparent material, semi-transparent material, a one way transparent material (i.e., one-way mirror). The degree of transparency of the lower enclosure material may be a function of the environment of use. For example, if the camera 12 is able to swivel within the housing then it may be desirable for the lower enclosure 20 to be semi-transparent or be fabricated from a one-way transparent material (i.e., one way mirror) such that those being observed do not know whether they are within the line of sight of the camera 12. The lower enclosure 20 may be fabricated from a combination of both a non-transparent material and a transparent material. For example, if the camera 12 within the housing 10 cannot swivel therein, then the lower enclosure 20 may be fabricated from a non-transparent material except for an aperture through which observation is desired and the aperture may be covered with a semi-transparent or one-way transparent material.

The mounting bracket 22 may define a wall base 38 and an enclosure base 40. The wall base 38 may be attachable to the wall 16 and the enclosure base 40 may be attachable to the upper enclosure 18. Although, in FIG. 1, the housing 10 is shown as being attached to the wall 16, the housing 10 may be attached to other types of structures such as planes, trains and automobiles. In other words, the attachment of the housing 10 to the wall 16 is merely exemplary of the present invention and is not meant to limit applicability of the various aspects of the present invention to a housing 10 which is attached to a wall 16. The wall base 38 may define a flat surface 42 which may be adhered, bolted, screwed or otherwise fixedly, slideably or rotateably attached to the wall 16. The enclosure base 40 may be adhered, bolted, screwed or otherwise fixedly attached to the upper enclosure's cylindrical portion 23. In particular, the enclosure base 40 may define a cylindrical depression 44 and the cylindrical configuration may be sized and configured to mate with the upper enclosure's cylindrical portion 23. In the alternative, the enclosure base 40 may define a flat surface which mates with a flat surface of the upper enclosure 18.

The heat pump 14 may comprise an internal heat sink 46 (see FIGS. 1-3), internal fan 48 (see FIGS. 1-3), peltier module 50 (see FIGS. 1 and 3), external heat sink 52 (see FIGS. 1-3), an external fan assembly 54 (see FIGS. 1-3) and a thermostat 56 (see FIG. 3) which may all be in electrical communication with each other. The peltier module may be a heat exchange unit or a thermo electric cooling mechanism. The peltier module may be model no. TEC1-127015 sold by THREE STONE. The peltier module 50 may be interposed between the internal heat sink 46 and the external heat sink 52. The internal and external heat sinks 46, 52 may be model nos. FH8025MF and FH10040MF sold by ALPHANOVATECH, respectively. Furthermore, the peltier module 52 and the heat sinks 46, 52 may be in physical contact with each other, as shown in FIG. 1. To further increase physical contact between the peltier module 50 and the heat sinks 46, 52, the heat sinks 46, 52 may be bolted to each other with the peltier module 50 interposed therebetween. Additionally, thermogrease may be coated or applied to the contact surfaces 58a, b (see FIG. 3) of the peltier module 50 and the heat sinks 46, 52. The bolting of the heat sinks 46, 52 with the peltier module 50 disposed therebetween and the thermogrease applied to the contact surfaces 58 are optional methods of maintaining and increasing the physical contact and resulting thermal heat transfer effectiveness or efficiency between the internal and external heat sinks 46, 52.

In the bolted connection, four apertures may be formed on each of the internal and external heat sinks 46, 52. Each of the four apertures formed on the internal heat sink 46 may be sized, configured and positioned with a respective one of the four apertures formed on the external heat sink 52. A bolt (e.g., 8/20 thread, stainless steel) may proceed through the respective apertures of the external and internal heat sinks 52, 46 and a nut may be screwed onto the bolt such that the internal and external heat sinks 46, 52 may apply pressure onto the peltier module 50 from both sides. For example, the nut may be tightened onto the bolt with a torque of ten (10) ft/lbs to apply the pressure onto the peltier module 50. Optionally, prior to the tightening of the bolt and nut, thermogrease (e.g., T412 sold by CHOMERICS) may be applied to the contact surfaces 58 of the internal heat sink 46, external heat sink 52 and peltier module 50. The thermogrease and the bolts, as discussed above, being for the purposes of maintaining and increasing the physical contact between the contact surfaces 58.

The internal heat sink 46 may define a base 60 which further defines a base surface 62 (see FIG. 3; i.e., entire surface and not limited to contact surface) and a plurality of fins 64 (see FIG. 3). The internal heat sink 46 may be fabricated from a material such as aluminum. The internal fan 48, which may be model no. MB6010x1281 sold by MECCATRONICS, may be positioned adjacent to the fins 64 of the internal heat sink 46. Furthermore, the internal fan 48 may blow air onto or away from the heat sink fins 64 so as to promote hot air (i.e., heat) within the housing 10 to circulate through the internal heat sink fins 64. The internal fan 48 may further serve the purposes of maintaining a uniform temperature within the housing 10 such that certain portions may not overheat. For example, when the housing 10 is placed outside, (i.e., not within a building) in direct contact with the sun, the sun may be directed to a particular side of the housing 10 so as to heat such side to a higher temperature compared to other areas or volumes within the housing 10. Accordingly, the internal fan 48 may circulate the air within the housing 10 such that the temperature differences within the housing 10 is reduced or eliminated. As such, if the internal heat sink fins 64 were located within a cooler part of the housing 10 then the internal fan 48 would move heat from hotter volumes of the housing 10 to such fins 64.

The external heat sink 52 may also define a base 66 which may further define a base surface 68 (see FIG. 3). The external heat sink 52 may be approximately three times as large compared to the internal heat sink 46. In particular, the base surface 66 of the external heat sink 52 may be approximately three times greater than the base surface 62 of the internal heat sink 46. As such, any heat which may be transferred from the internal heat sink 46 to the external heat sink 52 will not be impeded or restricted due to the heat transfer rate to the external heat sink 52. The external heat sink 52 may further define a plurality of fins 70 attached to the base 66. The external fan assembly 54 may be adjacent or attached to the external heat sink fins 70 so as to move hot air or heated air trapped between the external heat sink fins 70 away from the external heat sink 52. The external fan assembly 54 may comprise a first fan 72 (see FIGS. 1 and 3), second fan 74 (see FIG. 2), and third fan 76 (see FIG. 2) attached to each other within an enclosure 78. The first through third fans 72, 74, 76 may be model no. G9225x12B FS sold by MECCATRONICS. The first fan 72 may draw air away from the external heat sink fins 70 into the enclosure 78, and the second and third fans 74, 76 may blow or draw such air into the environment 80.

The peltier module 50, as discussed above, may be interposed between the internal and external heat sinks 46, 52. In this regard, the peltier module 50 may be oriented such that heat is drawn from the internal heat sink 46 and transferred to the external heat sink 52. Accordingly, as the inside temperature of the housing 10 increases, heat from the hot air therein is transferred to the internal heat sink 46 and actively pumped via the peltier module 50 to the external heat sink 52. Thereafter, the heat within the external heat sink 52 is expelled or transferred into the environment. In this regard, a temperature differential of about fifty (50) degrees Fahrenheit may be maintained between the housing inside temperature and the environmental temperature.

The heat pump 14 and the heat pump aperture 24 of the upper enclosure 18 may be sized and configured so as to mate with each other, as shown in FIGS. 1 and 2. In particular, the heat pump 14 may be fitted through the heat pump aperture 24. Although FIG. 1 shows the internal heat sink 46 fitted into the heat pump aperture 24, it is further contemplated within the scope of the present invention that the heat pump aperture 24 may circumscribe the peltier module 50. For example, a periphery of the heat pump aperture 24 may be sized and configured so as to be interposed between the base surfaces 62, 68 of the internal and external heat sinks 46, 52. The peltier module 50 may be fitted therein. The internal and external heat sinks 46, 52 may be placed on opposed sides of the peltier module 50 and pressed onto the peltier module contact surfaces 58. A rubber seal or o-ring may also be placed between the heat pump aperture 24 and the heat pump 14 so as to form a watertight or hermetically sealed connection therebetween.

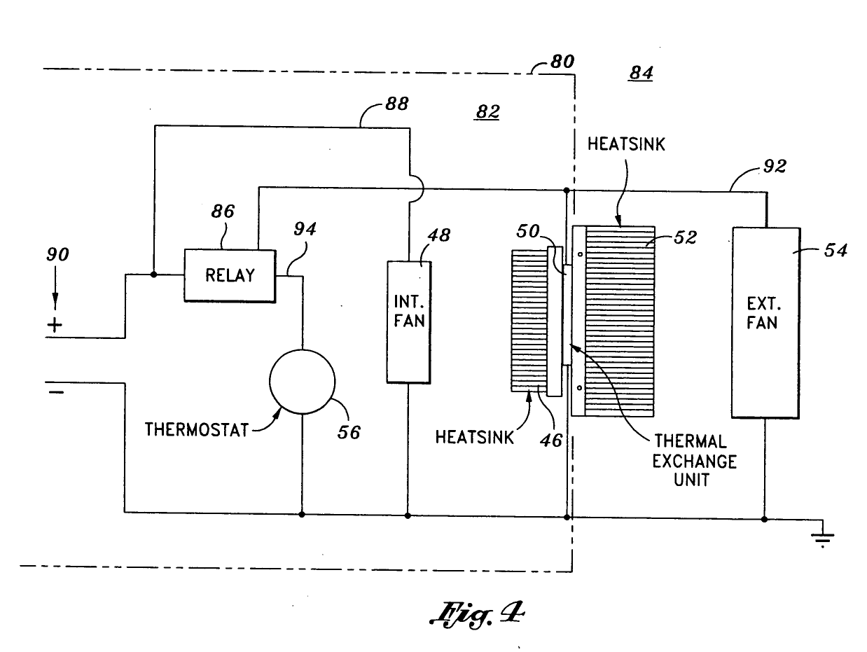

FIG. 4 illustrates a wiring design for the heat pump 14. Box 80 represents the housing with 82 representing the housing inside and 84 representing the environment. The thermostat 56 may be positioned within the housing 10 along with a relay 86. The thermostat 56 may be for the purposes of monitoring the inside temperature of the housing 10. The external fan assembly 54 and the peltier module 50 may be electrically powered through the power relay switch 86. In particular, a first circuit 88 may supply current to the internal fan 48 wherein the first circuit 88 is always closed. Accordingly, the internal fan 48 is continuously powered by power source 90 thereby constantly circulating the inside air of the housing 10. A second circuit 92 may supply current to the peltier module 50 and the external fan 54. The peltier module 50 and the external fan 54 may be thermostatically controlled. In other words, the peltier module 50 and the external fan 54 may be turned on or off as a function of a measured temperature of the housing inside temperature via thermostat 56. The thermostat 56 may be placed within the housing 10 so as to monitor the housing inside temperature.

To turn the peltier module 50 and the external fan 54 on or off, the relay 86 is closed or opened using a magnet which may be activated by third circuit 94. As shown in FIG. 4, the third circuit 94 is in electrical communication with the thermostat 56. The thermostat 56 may be programmed to close when the measured temperature is above a predetermined temperature which may also close the third circuit 94. When the third circuit 94 is closed, the same may activate the magnet in the relay 86 to thereby close the relay 86. When the relay 86 is closed, the second circuit 92 is closed and causes current to flow to the peltier module 50 and the external fan 54 to thereby activate the heat pump 14. In the alternative, when the measured inside temperature of the housing 10 is below the predetermined temperature, the thermostat 56 may be programmed to open which opens the third circuit 94 and prevents any current from flowing to the magnet in the relay 86. This deactivates the magnet and the relay 86 is opened. The opened relay 86 prevents current from flowing through the third circuit to the peltier module 50 and the external fan 54 to thereby deactivate the heat pump 14. In sum, the internal fan 48 continuously circulates the air within the housing 10 so as to maintain a uniform temperature throughout the inside volume of the housing 10 and prevent any significant temperature differences therein. In other words, localized heat is distributed toward the internal heat sink 46. Also, the peltier module 50 and the external fan 54 may be selectively activated based on whether the measured inside temperature of the housing 10 is greater than or less than the predetermined temperature. The predetermined temperature may be equal to or less than an operating temperature of an electronic device 12 contained within the housing 10.

By way of example and not limitation, the electronic device 12 may be a camera 12 (see FIG. 1), a surveillance camera, or a sound sensing device. Further, as shown in FIG. 1, the electronic device 12 may rotate within the housing 10. These devices may define the operating temperature. The operating temperature being a maximum temperature at which the electronic device 12 may operate. When the electronic device 12 is placed within the housing and the housing 10 is subjected to heating via direct contact with the sun or environmentally (e.g., Mojave Desert), the housing inside temperature may rise above the electronic device operating temperature. In this regard, the heat pump 14 may be activated when the housing measured inside temperature equals the operating temperature or prior to the housing measured inside temperature reaching the operating temperature. In the latter, a predetermined temperature may be set below the electronic device operating temperature.

In another aspect of the present invention, a method of constructing the housing 10 adapted to the heat pump 14 is provided. The method may comprise the steps of forming the heat pump aperture 24 in the upper enclosure 18. The heat pump aperture 24 may be sized and configured to fit the peltier module 50. The peltier module 50 is provided and mounted in the heat pump aperture 24. Optional thermogrease may be applied to the peltier module 50, and more particularly, to its contact surfaces 58 which may ultimately physically contact the internal and external heat sinks 46, 52. The external and internal heat sinks 46, 52 with four apertures each formed therein may be aligned with each other. Bolts may be inserted through respective apertures of the internal and external heat sinks 46, 52 and nuts may be screwed onto the bolts to tighten the internal and external heat sinks 46, 52 onto the peltier module 50. An internal fan 48 may be mounted adjacent to the internal heat sink 46 and an external fan 54 may be mounted adjacent to the external heat sink 52. A desicant chemical agent 96 may be placed inside of the housing 10 so as to prevent the formation of condensation due to the temperature difference between the housing inside temperature and the exterior ambient temperature.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art. It should be noted and understood that with respect to the embodiments of the present invention, the materials suggested may be modified or substituted to achieve the general overall resultant high efficiency. The substitution of materials or dimensions remains within the spirit and scope of the present invention.

1. An electronic device enclosure for an articulating electronic device, the enclosure comprising:
a. a housing having a housing wall said housing wall defining the housing interior and housing exterior, the housing sized and configured to contain the articulating electronic device and at least one domed portion and allow movement of the device in the domed portion of the housing;
b. an aperture formed in said housing wall;
c. a heat pump positioned within said aperture for transferring heat from the housing interior to the housing exterior; and
d. an internal fan disposed inside the housing to direct heat to the heat pump.

2. The enclosure of claim 1 wherein the heat pump is a thermo electric cooling mechanism.

3. The enclosure of claim 1 wherein the heat pump is selectively activated based on a measured temperature of a thermostat positioned within the housing.

4. The enclosure of claim 2 wherein the heat pump is activated when the measured temperature is greater than a predetermined temperature.

5. The enclosure of claim 1 wherein the heat pump is a peltier module.

6. The enclosure of claim 1 wherein the electronic device is a camera.

7. The enclosure of claim 1 wherein the housing comprises an upper member and a lower domed member, the upper member being disposed above the lower domed member, and the heat pump aperture being formed in the upper member.

8. The enclosure of claim 1 wherein the heat pump comprises:
a. a first heat sink positioned in the housing interior; and
b. a thermo electric cooling mechanism attached to the first heat sink in heat transfer relation.

9. The housing of claim 8 further comprising a second heat sink positioned such that at least a portion of said second heat sink is exterior to the housing and wherein said second heat sink is attached in heat transfer relation to the thermoelectric cooling mechanism.

10. The enclosure of claim 9 wherein pressure is applied to the thermo electric cooling mechanism by the internal and external heat sinks with a nut and bolt.

11. The enclosure of claim 9 further comprising thermo grease applied to contact surfaces of the cooling mechanism.

12. The enclosure of claim 9 wherein the first and second heat sinks each define a base plate and respective base plate areas, and the base plate area of the external heat sink is about three times larger than the base plate area of the first heat sink.

13. The enclosure of claim 9 further comprising an external fan proximate to the second heat sink for displacing air away from the second heat sink.

14. The enclosure of claim 13 wherein the external fan is selectively activated based on a measured temperature of a thermostat positioned within the housing.

15. The enclosure of claim 14 wherein the external fan is activated when the measured temperature in the housing exceeds a predetermined temperature.

16. The enclosure of claim 8 wherein the internal fan positioned inside the housing circulates air over the first heat sink.

17. The enclosure of claim 16 wherein the internal fan is continuously operated.

18. An enclosure for an articulating electronic device, the enclosure comprising:
a. a housing having at least one domed portion, wherein the said housing is sized and configured to contain the articulating electronic device, and allow movement of the device in the domed portion of the housing the housing having a heat pump aperture;
b. a heat pump attached to the housing at the heat pump aperture for pumping heat inside the enclosure to outside the enclosure, the heat pump comprising a heat exchange unit attached to a base of an internal heat sink with internal heat sink fins positioned within the enclosure for absorbing heat from inside the housing and transferring such absorbed heat through the heat exchange unit to the environment.

19. The housing of claim 18 further comprising an internal fan within the enclosure for circulating the air therewithin to direct heat to the internal heat sink.

20. The housing of claim 19 wherein the internal fan operates continuously.

21. An electronic device assembly comprising:
an articulating electronic device; and
a housing containing the articulating electronic device, the electronic device being articulateable within the housing, the housing comprising:
an upper enclosure with an aperture formed elevationally higher than the articulating electronic device;
a heat pump positioned within the aperture for pumping heat inside the enclosure to outside the enclosure; and
a lower enclosure sized and configured to the upper enclosure.

22. The assembly of claim 21 wherein the electronic device is rotateable within the housing.

23. A method of manufacturing an enclosure for an articulating electronic device, the method comprising the steps of:
a. providing a housing having an upper enclosure and a mating lower enclosure the upper enclosure formed with an aperture in which a heat pump will be positioned the aperture being elevationally higher than the articulating electronic device to be enclosed within the housing;
b. providing a heat pump; and
c. attaching the heat pump to the housing by positioning the heat pump in the aperture.

24. The method of claim 23 wherein the heat pump step further comprises the steps of:
a. providing an internal heat sink;
b. providing an external heat sink; and
c. providing an interposed thermo electric cooling mechanism.

25. The method of claim 24 wherein the attaching step further comprises the steps of:
a. placing the internal heat sink at least partially inside of the enclosure;
b. placing the external heat sink at least partially outside the enclosure; and
c. placing the cooling mechanism interpositionally between the internal and external heat sinks.

26. The method of claim 25 further comprising the steps of pressing the internal heat sink and the external heat sink onto the peltier module.

27. The method of claim 26 wherein the pressing step is accomplished via a nut and bolt.

28. The method of claim 25 wherein the external heat sink and the internal heat sink each define a base plate which further defines a base plate area, and the base plate area of the external heat sink is at least about three times larger compared to the base plate area of the internal heat sink.

29. (canceled)

30. (canceled)
